(19) United States
(12) Patent Application Publication
(10) Pub. No.: US 2006/0198290 A1
(43) Pub. Date: Sep. 7, 2006

(54) Cover layer structure for optical data storage media

(76) Inventors: Barry E. Brovold, St. Paul, MN (US); Donald J. Kerfeld, Grey Eagle, MN (US)

Correspondence Address: Imation Corp., PO Box 64898, St. Paul, MN, 55164-0898, US

(21) Appl. No.: 11/070,102

(22) Filed: Mar. 1, 2005

(51) Int. Cl. G11B 7/24

(52) U.S. Cl. 369/275.5

(57) ABSTRACT

The invention is directed to a cover layer structure for an optical data storage disk. The cover layer structure includes an optically transmissive layer, a first material distributed over a top surface of the optically transmissive layer, and a second material distributed over a bottom surface of the optically transmissive layer. The first and second materials may comprise curable materials optically matched to the optically transmissive layer. The optically transmissive layer defines substantial thickness variations larger than approximately ±2 micrometers. The first and second materials are distributed over the optically transmissive layer such that a thickness variation tolerance of the cover layer structure is less than approximately ±2 micrometers. In some cases, the first material may comprise a hardcoat material and a single structure comprising both the hardcoat material and the optically transmissive layer may bond to a substrate of the optical data storage disk.

### TECHNICAL FIELD

The invention relates to data storage media and, more particularly, optical data storage media.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase change optical disks, and others. Some newer formats for optical data storage disks are progressing toward smaller disk sizes and increased data storage density. For example, some new media formats boast improved track pitches and increased storage density using blue-wavelength lasers for data readout and/or data recording.

Optical data storage disks are typically produced by first making a data storage disk master that has a surface pattern that represents encoded data on the master surface. The surface pattern, for instance, may be a collection of grooves or other features that define master pits and master lands, e.g., typically arranged in either a spiral or concentric manner. The master is typically not suitable as a mass replication surface with the master features defined within an etched photoresist layer formed over a master substrate.

After creating a suitable master, that master can be used to make a stamper, which is less fragile than the master. The stamper is typically formed of electroplated metal or a hard plastic material, and has a surface pattern that is the inverse of the surface pattern encoded on the master. An injection mold can use the stamper to fabricate large quantities of replica disks. Also, photopolymer replication processes, such as rolling bead processes, have been used to fabricate replica disks using stampers. In any case, each replica disk may contain the data and tracking information that was originally encoded on the master surface and preserved in the stamper. The replica disks can be coated with a reflective layer and/or a phase change layer, and are often sealed with an additional protective layer.

Blue disk media formats, such as Blu-Ray and HD-DVD, may also use similar mastering-stamping techniques. The blue disk media formats may be compatible with a blue-laser drive head that operates at a wavelength of approximately 405 nm. As used herein, the term blue disk media (or blue disks) refers to optical disk media having a data storage capacity of greater than 15 gigabytes (GB) per data storage layer of the disk. The blue disk media formats include optically transmissive cover layers bonded over the optical disk with different thicknesses specified by the different blue disk media formats. As an example, the media construction may hold the cover layer material to the specified thickness within a ±2 μm tolerance over the entire surface of the optical disk. Therefore, the cover layer material typically comprises an expensive, high quality cast material capable of being held to the tight thickness tolerance.

### SUMMARY

In general, the invention is directed to a cover layer structure for an optical data storage disk. The cover layer structure includes an optically transmissive layer, a first material distributed over a top surface of the optically transmissive layer, and a second material distributed over a bottom surface of the optically transmissive layer. The optically transmissive layer may comprise a rigid polymer. The first and second materials may comprise curable materials optically matched to the optically transmissive layer.

The optically transmissive layer comprises an inexpensive, lower quality material that defines substantial thickness variations larger than approximately ±2 micrometers. However, the first and second materials are distributed over the optically transmissive layer such that a thickness variation tolerance of the cover layer structure is less than approximately ±2 micrometers. The first and second materials fill the surface variations defined in the low quality material of the optically transmissive layer to improve the overall surface quality of the cover layer structure.

In some cases, the first material may comprise a hardcoat material and the second material may comprise a bonding material. A support carrier may temporarily bond to the cover layer structure via the hardcoat material. The support carrier may then apply the cover layer structure to a substrate of the optical data storage disk. In this way, a single structure comprising both the hardcoat material and the optically transmissive layer may bond to the substrate via the bonding material.

A stamper may be applied to the bonding material to create features in the bonding material. In other words, the stamper replicates a surface pattern that represents encoded data in the bonding material. The cover layer structure may then be bonded to the substrate of the optical data storage disk via the encoded bonding material. A surface of the substrate adjacent the surface pattern encoded on the bonding material may include a coating of thin films. In other embodiments, the cover layer structure may include another surface pattern encoded on a replication material interposed between the bottom surface of the optically transmissive layer and the bonding material.

In some cases, the optical data storage disk may comprise a blue disk medium, i.e., an optical disk medium compatible with a blue-laser drive head and having storage capacity of greater than 15 gigabytes. The blue-laser drive head may operate at a wavelength of approximately 405 nm. As used herein, the term blue disk media (or blue disks) refers to optical disk media having a data storage capacity of greater than 15 gigabyte (GB) per data storage layer of the disk. Examples of blue disk media include Blu-Ray and HD-DVD, but other future generations of optical disks may also comprise blue disk media.

In one embodiment, the invention is directed to a cover layer structure for an optical data storage disk comprising an optically transmissive layer defining an index of refraction. The cover layer structure further comprises a first material distributed adjacent a top surface of the optically transmissive layer, the first material defining an index of refraction that substantially matches the index of refraction of the optically transmissive layer. The cover layer structure further comprises a second material distributed adjacent a bottom surface of the optically transmissive layer, the second material defining an index of refraction that substantially matches the index of refraction of the optically transmissive layer. The optically transmissive layer also defines substantial thickness variations larger than approximately ±2 micrometers. The first and second materials are distributed such that a thickness variation tolerance of the cover layer structure is less than approximately ±2 micrometers.

In another embodiment, the invention is directed to an optical data storage disk comprising a substrate and a cover layer structure bonded to the substrate. The cover layer structure includes an optically transmissive layer defining substantial thickness variations larger than approximately ±2 micrometers, the optically transmissive layer defining an index of refraction. The cover layer structure also includes a first material distributed adjacent a top surface of the optically transmissive layer, the first material defining an index of refraction that substantially matches the index of refraction of the optically transmissive layer. The cover layer structure further includes a second material distributed adjacent a bottom surface of the optically transmissive layer, the second material defining an index of refraction that substantially matches the index of refraction of the optically transmissive layer. The first and second materials are distributed such that a thickness variation tolerance of the cover layer structure is less than approximately ±2 micrometers.

In another embodiment, the invention is directed to a method comprising forming a cover layer structure including an optically transmissive layer, a hardcoat material distributed adjacent a top surface of the optically transmissive layer, and a bonding material distributed adjacent a bottom surface of the optically transmissive layer, and temporarily bonding a support carrier to the cover layer structure via the hardcoat material. The method further comprises applying the cover layer structure to an optical data storage disk substrate with the support carrier, bonding the cover layer structure to the optical data storage disk substrate via the bonding material, and removing the support carrier to expose the hardcoat material.

The invention may be capable of providing one or more advantages. For example, the invention integrates a hardcoat material into a cover layer structure to protect the optically transmissive layer against scratches and fingerprints, which may be detrimental to the readability of the stored data. Integrating the hardcoat eliminates a separate hardcoat application process, such as spin coating or vacuum deposition, which often lacks the uniformity needed to maintain the ±2 μm thickness variation tolerance of the cover layer structure. Furthermore, the invention reduces the manufacturing cost by using a less expensive, lower quality material for the optically transmissive layer in the cover layer structure. In particular, the optically transmissive layer defines an index of refraction and each of the first and second materials distributed over the optically transmissive layer define an index of refraction that substantially matches the index of refraction of the optically transmissive layer. In this way, the first and second materials may function as part of the optically transmissive layer and compensate for irregularities in the optically transmissive layer.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an optical data storage disk.

FIGS. 2A-2C are block diagrams collectively illustrating a process of creating a cover layer structure, and then bonding the cover layer structure to a substrate to form an optical data storage disk.

FIG. 3 is a flow chart illustrating the exemplary process of FIGS. 2A-2C.

FIGS. 4A-4E are block diagrams collectively illustrating a process of creating another cover layer structure, and then bonding the cover layer structure to a substrate to form an optical data storage disk.

FIG. 5 is a flow chart illustrating the exemplary process of FIGS. 4A-4E.

FIGS. 6A-6C are cross-sectional side views of a knife-edged gap system.

### DETAILED DESCRIPTION

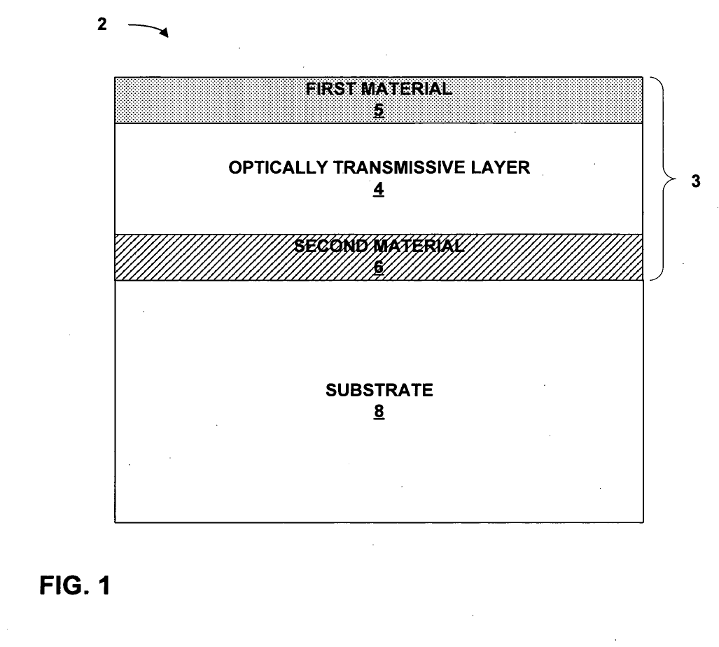

FIG. 1 is a block diagram illustrating an optical data storage disk 2. Optical data storage disk 2 includes a substrate 8 and a cover layer structure 3 bonded adjacent a surface of substrate 8. Optical data storage disk 2 may comprise a blue disk medium, i.e., an optical disk medium compatible with a blue-laser drive head. The blue-laser drive head may operate at a wavelength of approximately 405 nm. As used herein, the term blue disk media (or blue disks) refers to optical disk media having a data storage capacity of greater than 15 gigabyte (GB) per data storage layer of the disk. Examples of blue disk media include Blu-Ray and HD-DVD.

Cover layer structure 3 comprises an optically transmissive layer 4, a first material 5 distributed over a top surface of optically transmissive layer 4, and a second material 6 distributed over a bottom surface of optically transmissive layer 4. Optically transmissive layer 4 may comprise a rigid polymer, such as polycarbonate or polyvinyl chloride (PVC). Optically transmissive layer 4 defines an index of refraction. Each of first material 5 and second material 6 defines an index of refraction that substantially matches the index of refraction of optically transmissive layer 4. In this way, first and second materials 5 and 6 may function as part of optically transmissive layer 4.

In addition, first and second materials 5 and 6 may comprise curable resins. Therefore, optically transmissive layer 4 may comprise a less expensive, low quality material that defines substantially thickness variations larger than approximately ±2 μm. First material 5 and second material 6 distributed over optically transmissive layer 4 may fill the variations of optically transmissive layer 4 such that cover layer structure 3 has a thickness variation tolerance of less than approximately ±2 μm.

In some embodiments, first material 5 may comprise a hardcoat material capable of protecting optically transmissive layer 4 from scratches and fingerprints. Furthermore, in some embodiments, second material 6 may comprise a bonding material. In that case, cover layer structure 3 may bond to substrate 8 via second material 6 to form optical disk 2. In other embodiments, first material 5 and second material 6 may simply allow cover layer structure 3 to use a lower quality optically transmissive layer 4. In that case, a separate bonding material may be used to bond cover layer structure 3 to substrate 8.

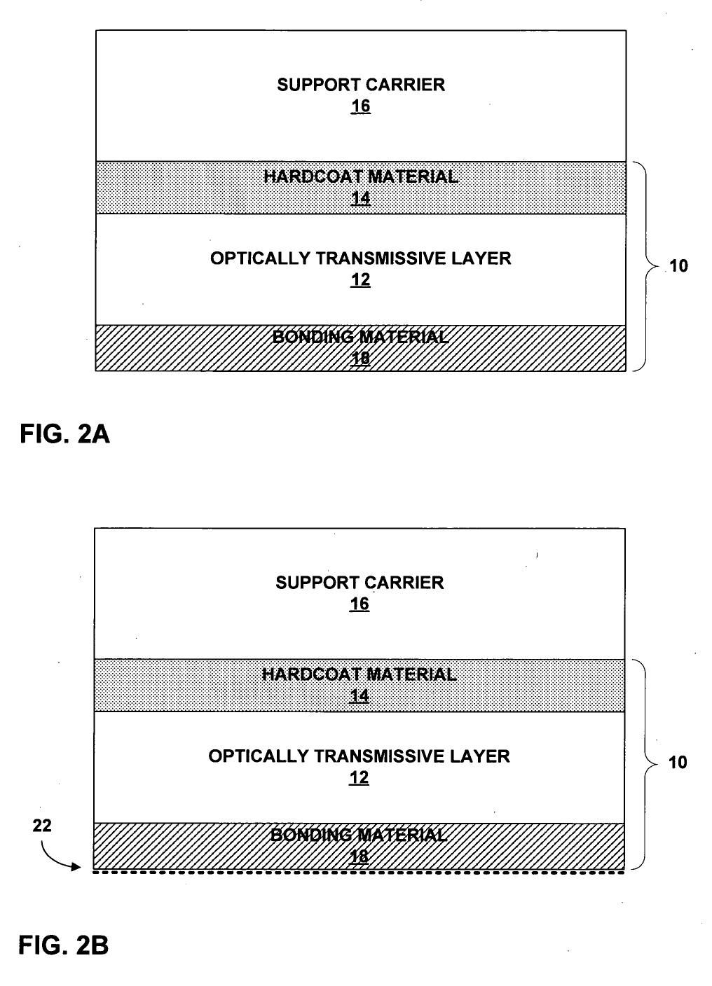

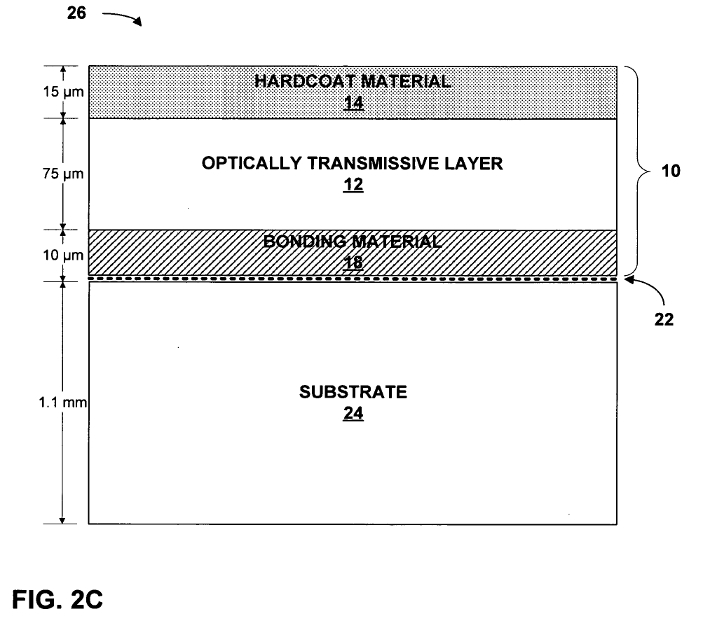

FIGS. 2A-2C are block diagrams collectively illustrating a process of creating a cover layer structure 10, and then bonding cover layer structure 10 to a substrate 24 to form an optical data storage disk 26. Optical data storage disk 26 may be substantially similar to optical data storage disk 2 from FIG. 1. In the illustrated embodiment, optical data storage disk 26 comprises a blue disk medium. Optical data storage disk 26 illustrated in FIG. 2C conforms to a blue disk medium format in which substrate 24 comprises a thickness of approximately 1.1 mm and cover layer structure 10 comprises a thickness of approximately 0.1 mm with a ±2 μm thickness variation tolerance. In other embodiments, optical data storage disk 26 may comprise other optical media types and conform to other optical media formats.

FIG. 2A illustrates a support carrier 16 and a cover layer structure 10 according to an embodiment of the invention. Cover layer structure 10 includes an optically transmissive layer 12, a hardcoat material 14 distributed over a top surface of optically transmissive layer 12, and a bonding material 18 distributed over a bottom surface of optically transmissive layer 12. Cover layer structure 10 integrates hardcoat material 14 to protect optically transmissive layer 12 against scratches and fingerprints. In this way, hardcoat material 14 eliminates the need to enclose optical disk 26 within a cartridge for protection.

In addition, integrating hardcoat material 14 into cover layer structure 10 eliminates a separate hardcoat application process. Conventionally, a hardcoat material is applied via a spin coating technique or a vacuum deposition technique over an optically transmissive layer bonded to a substrate of an optical medium. However, these techniques often lack the uniformity needed to maintain a thickness within the tight tolerances prescribed by some optical medium formats, such as blue-ray and HD-DVD. For example, a spin coating technique applied to a flat surface of an optically transmissive layer tends to apply a thicker coating around the edges of the optical medium. In that case, the edges of the cover layer may be outside the thickness variation tolerance. Therefore, the conventional hardcoat application techniques may be incompatible with the goal of achieving cover layer structure 10 within the ±2 μm thickness variation tolerance, as described herein.

Cover layer structure 10 comprises a thickness within the tight tolerance to allow an optical disk drive to focus a light onto a surface of substrate 24 through cover layer structure 10. Hardcoat material 14 and bonding material 18 may be optically matched to optically transmissive layer 12. Specifically, the index of refraction of optically transmissive layer 12 may be between approximately 1.45 and 1.70, the index of refraction of hardcoat material 14 may be between approximately 1.45 and 1.70, and the index of refraction of bonding material 18 may be between approximately 1.45 and 1.70.

As the indices of refraction increase within the given range, the allowable thickness range of cover layer structure 10 also increases. For example, if optically transmissive layer 12, hardcoat material 14, and bonding material 18 each define an index of refraction of 1.45, the allowable thickness range is approximately 93.75 μm to 103.75 μm. If optically transmissive layer 12, hardcoat material 14, and bonding material 18 each define an index of refraction of 1.70, the allowable thickness range is approximately 97.5 μm to 107.5 μm. As described herein, each of the allowable thicknesses for cover layer structure 10 has a thickness variation tolerance of less than approximately ±2 μm.

In this way, hardcoat material 14 and bonding material 18 may function as part of optically transmissive layer 12. In other words, the light may pass through cover layer structure 10 in a substantially similar manner as passing through a single layer of material, e.g., optically transmissive layer 12. In the illustrated embodiment, hardcoat material 14 and bonding material 18 comprise ultra-violet (UV) materials to optically match with optically transmissive layer 12 of the blue disk medium. Thus, the final cover layer structure 10 comprises a tri-layer structure including hardcoat material 14, optically transmissive layer 12 and bonding material 18 optically matched to one another.

Optically transmissive layer 12 may comprise a polycarbonate material or a polyvinyl chloride (PVC) material. Hardcoat material 14 and bonding material 18 may comprise curable materials, such as a resin or a polymer. Optically transmissive layer 12 may comprise a low cost material with thickness variations larger than approximately ±2 μm. Distributing curable materials 14 and 18 over the top and bottom surfaces of optically transmissive layer 12 fills the surface variations in the material of optically transmissive layer 12. In this way, cover layer structure 10 may maintain the ±2 μm thickness variation tolerance across optical disk 26 even when optically transmissive layer 12 is outside of the tolerance range. Thus, the invention provides an easy way to create low cost cover layer structures having high quality optical performance needed to meet the specifications of particular optical media formats, such as Blu-Ray and HD-DVD.

Support carrier 16 temporarily bonds to cover layer structure 10 via hardcoat material 14. Support carrier 16 allows cover layer structure 10 to be transported and applied to substrate 24 (FIG. 2C) of optical data storage disk 26. Support carrier 16 also provides rigidity that enables cover layer structure 10 to be sized according to the dimensions of substrate 24. In addition, support carrier 16 provides a flat surface, which may improve a surface quality of hardcoat material 14.

A stamper may be applied to bonding material 18 to create features in bonding material 18. The stamper may be formed from an optical data storage disk master. The stamper defines a surface pattern that represents encoded data that can be replicated onto bonding material 18. The surface pattern, for instance, may be a collection of grooves or other features that define pits and lands, e.g., typically arranged in either a spiral or concentric manner.

The surface pattern formed on the stamper is the inverse of the desired pattern to be replicated on bonding material 18. The stamper can be created using any conventional stamper creation process. Typically, a fragile master disk is created using a photo-replication process. The fragile master can then be coated with a thin layer of nickel and electroplated to create a first generation stamper. The first generation stamper can be removed from the master and then used to create subsequent generation stampers, if desired.

Once an adequate stamper is created, the stamper can be used to form features in bonding material 18. A rolling bead process or a knife-edged process may be used to apply the stamper to bonding material 18. When the stamper is made to contact bonding material 18, a stamper surface pattern encodes bonding material 18 with a surface pattern that is the inverse of the stamper surface pattern. In this way, bonding material 18 may be encoded with the data and tracking information that was originally encoded on the master surface.

Cover layer structure 10 may be formed by a knife-edged gap process, described in more detail below, in which two or more layers are pulled through the knife-edged gap to distribute beads of material positioned between the layers. For example, a bead of hardcoat material 14 may be positioned between support carrier 16 and a top surface of optically transmissive layer 12 and a bead of bonding material 18 may be positioned between a bottom surface of optically transmissive layer 12 and the stamper. When support carrier 16, optically transmissive layer 12, and the stamper are pulled through a knifed-edged gap that is set to a specified thickness, hardcoat material 14 and bonding material 18 distribute over the top surface and the bottom surface, respectively, of optically transmissive layer 12.

FIG. 2B illustrates cover layer structure 10 with a surface pattern 22. Removing the stamper exposes surface pattern 22 encoded on bonding material 18. As discussed above, surface pattern 22 is an inverse of the stamper surface pattern. In some cases, the stamper may include a release agent, such as a Nickel (Ni) thin film, that allows the stamper to be removed from bonding material 18.

FIG. 2C illustrates optical data storage disk 26. Cover layer structure 10 bonds to substrate 24 via encoded bonding material 18 to form optical disk 26. Substrate 24 may include a coating of thin films on the surface adjacent bonding material 18. For example, the thin films may include a reflective material, a partially-reflective material, a phase-change material, or any other material used in creating machine readable features in an optical disk. Surface pattern 22 encoded on bonding material 18 may provide a surface relief pattern for the thin films deposited on the surface of substrate 24. In this way, the data and tracking information that was originally encoded on the master surface may be encoded on optical disk 26.

Once cover layer structure 10 bonds to substrate 24, support carrier 16 may be removed to expose hardcoat material 14. Support carrier 16 may comprise a material capable of temporarily bonding to hardcoat material 14 to provide handling support and surface quality, but not permanently adhere to hardcoat material 14.

As stated above, optical disk 26 conforms to a blue disk medium format. In the illustrated embodiment, substrate 24 comprises a thickness of approximately 1.1 mm. Cover layer structure 10 comprises a thickness of 100±2 μm. As an example, optically transmissive layer 12 may be approximately 75 μm thick, hardcoat material 14 may be approximately 15 μm, and encoded bonding material 18 may comprise a thickness of approximately 10 μm. In other embodiments, the components of cover layer structure 10 may conform to different thicknesses as long as the total thickness is within the ±2 μm thickness variation tolerance.

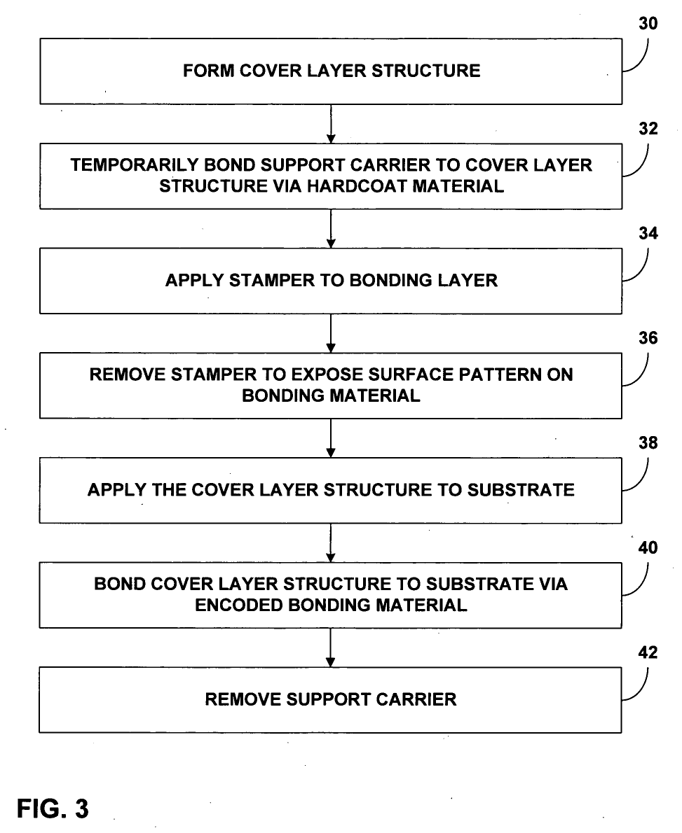

FIG. 3 is a flow chart illustrating an exemplary process of bonding cover layer structure 10 to substrate 24 to form optical data storage disk 26 (FIGS. 2A-2C). Cover layer structure 10 is formed by distributing hardcoat material 14 over the top surface of optically transmissive layer 12 and distributing bonding material 18 over the bottom surface of optically transmissive layer 12 (30).

As described above, cover layer structure 10 comprises a thickness, e.g., 100 μm, within a ±2 μm thickness variation tolerance. Materials 14 and 18 comprise curable materials capable of filling in variations on the surfaces of optically transmissive layer 12. Therefore, distributing materials 14 and 18 over a top and bottom surface, respectively, of optically transmissive layer 12 allows cover layer structure 10 to be within the thickness tolerance even with a less expensive, lower quality optically transmissive layer material.

Furthermore, integrating hardcoat material 14 into cover layer structure 10 eliminates a separate hardcoat application process that typically lacks uniformity, e.g., spin coating or vacuum deposition. Eliminating this application process may improve surface uniformity, which enables cover layer structure 10 to maintain a thickness within the tight tolerance across optical disk 26.

Optically transmissive layer 12 defines an index of refraction. Hardcoat material 14 and bonding material 18 are optically matched to optically transmissive layer 12 to allow an optical disk drive to focus a light onto a surface of substrate 24 through cover layer structure 10. In this way, hardcoat material 14 and bonding material 18 may function as part of optically transmissive layer 12 and compensate for irregularities in optically transmissive layer 12.

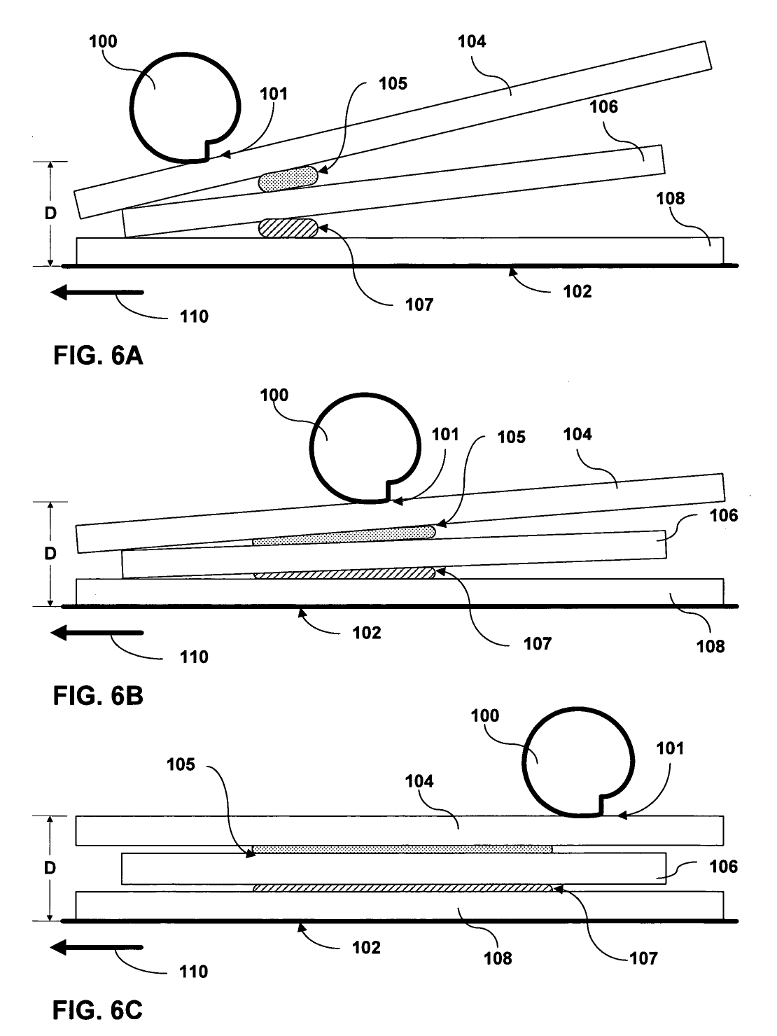

Support carrier 16 temporarily bonds to cover layer structure 10 via hardcoat material 14 (32). Support carrier 16 provides handling support to transport cover layer structure 10 and size cover layer structure 10 to fit substrate 24 of optical disk 26. A stamper is applied to bonding material 18 (34). The stamper includes a surface pattern that encodes surface pattern 22 on bonding material 18. The stamper is then removed to expose surface pattern 22 (36). The stamper may include a release agent, e.g., Ni thin film, to enable the removal processes. As described above, cover layer structure 10 may be formed using support carrier 16, optically transmissive layer 12, and the stamper in a knife-edged gap process, illustrated in FIGS. 6A-6C. In that case, a flat surface of support carrier 16 may provide improved surface quality to hardcoat material 14.

Support carrier 16 applies cover layer structure 10 encoded with surface pattern 22 to substrate 24 of optical disk 26 (38). Cover layer structure 10 bonds to substrate 24 via encoded bonding material 18 to form optical data storage disk 26 (40). Thin films, such as reflective materials, partially reflective materials, and phase-change materials, may be applied to a surface of substrate 24 adjacent bonding material 18 prior to bonding cover layer structure 10 to substrate 24. Surface pattern 22 may provide for encoding of the thin films on substrate 24 with data and tracking information. Support carrier 16 is then removed to expose hardcoat 14 (42). Support carrier 16 may comprise any material that allows temporary bonding to provide handling support without permanently adhering to cover layer structure 10.

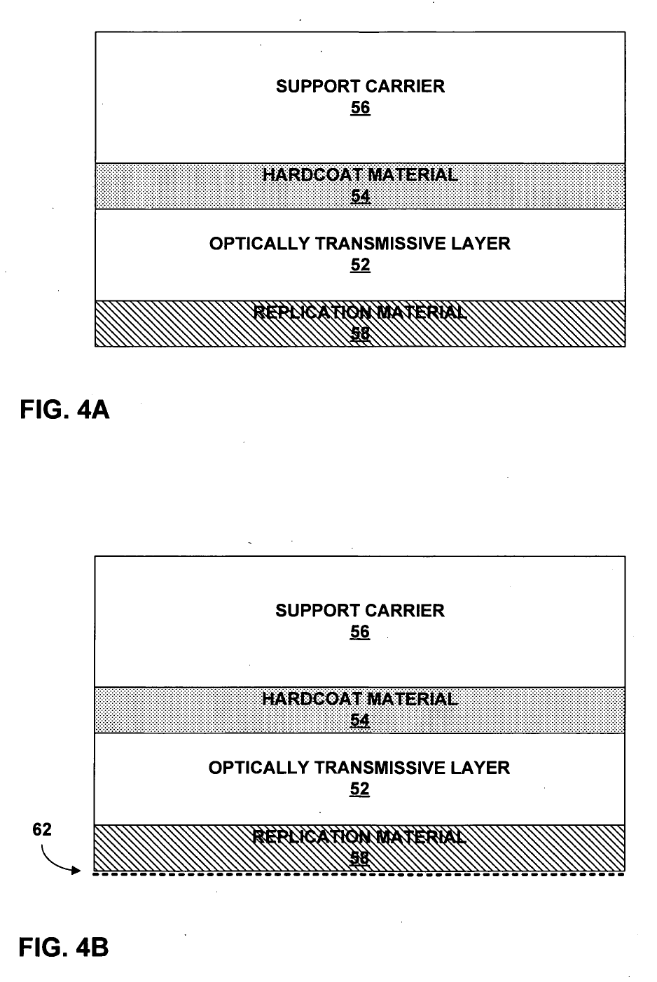

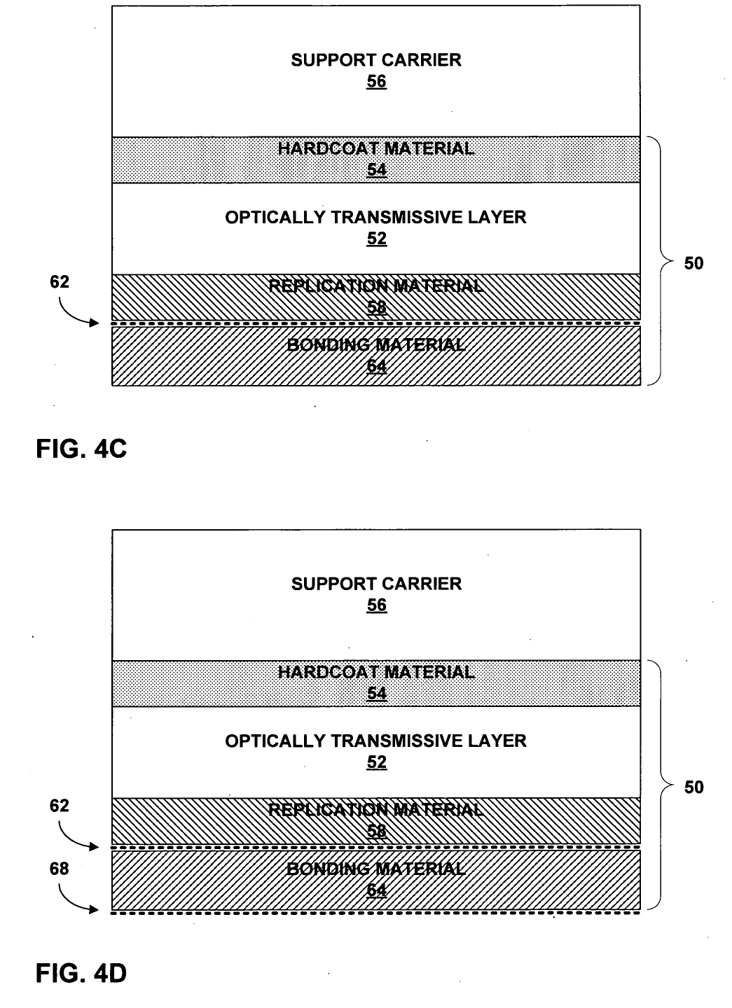

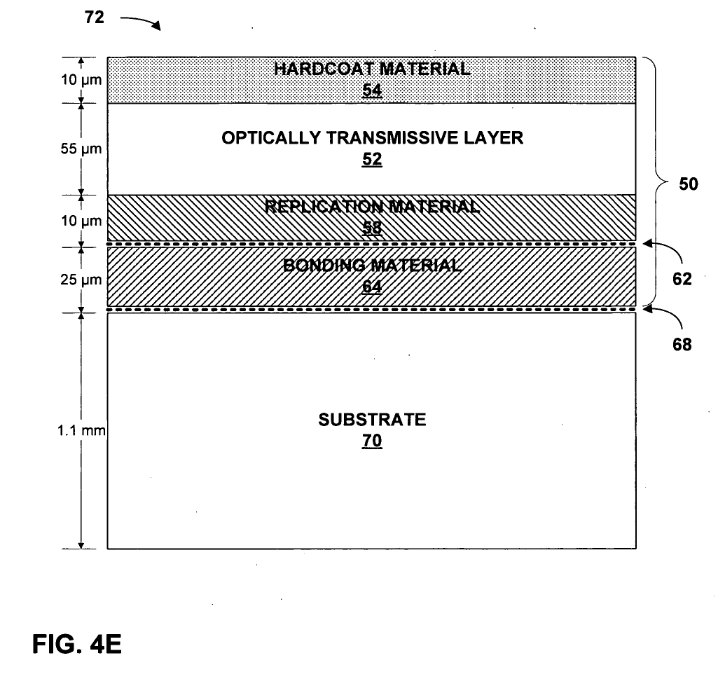

FIGS. 4A-4E are block diagrams collectively illustrating a process of creating another cover layer structure 50, and then bonding cover layer structure 50 to a substrate 70 to form an optical data storage disk 72. Optical data storage disk 72 may be substantially similar to optical data storage disk 2 from FIG. 1. In the illustrated embodiment, optical data storage disk 72 comprises a blue disk medium. Optical data storage disk 72 illustrated in FIG. 4E conforms to a dual-layer blue disk medium format in which substrate 70 comprises a thickness of approximately 1.1 mm and cover layer structure 50 comprises a thickness of approximately 0.1 mm with a ±2 μm thickness variation tolerance. In other embodiments, optical data storage disk 72 may comprise other optical media types and conform to other optical media formats. The films may be applied over each information encoded layer of structure 50, e.g., at 62 and 68.

Cover layer structure 50 includes an optically transmissive layer 52, a hardcoat material 54 distributed over a top surface of optically transmissive layer 52, a bonding material 64 distributed adjacent a bottom surface of optically transmissive layer 12, and a replication material 58 interposed between the bottom surface of optically transmissive layer 12 and bonding material 64.

FIG. 4A illustrates a support carrier 56 temporarily bonded to a portion of cover layer structure 50 via hardcoat material 54. Hardcoat material 54 is distributed over the top surface of optically transmissive layer 52 and replication material 58 is distributed over the bottom surface of optically transmissive layer 52. Cover layer structure 50 integrates hardcoat material 54 to protect optically transmissive layer 52 against scratches and fingerprints. In this way, hardcoat material 54 eliminates the need to enclose optical disk 72 within a cartridge for protection.

In addition, integrating hardcoat material 54 into cover layer structure 50 eliminates a separate hardcoat application process. Conventional application techniques, e.g., spin coating or vacuum deposition, often lack the uniformity needed to maintain a thickness within the tight tolerances prescribed by some optical medium formats, such as blue-ray and HD-DVD. For example, a spin coating technique applied to a flat surface of an optically transmissive layer tends to apply a thicker coating around the edges of the optical medium. In that case, the edges of the cover layer may be outside the thickness variation tolerance. Therefore, the conventional hardcoat application techniques cannot be used to achieve cover layer structure 50 within the ±2 μm thickness variation tolerance, as described herein.

Optically transmissive layer 52 may comprise a polycarbonate material or a PVC material. Hardcoat material 54 and replication material 58 may comprise curable materials, such as a resin or a polymer. Optically transmissive layer 52 may comprise a relatively inexpensive material with thickness variations larger than ±2 μm. Distributing curable materials 54 and 58 over the top and bottom surfaces of optically transmissive layer 52 fills the surface variations in the material of optically transmissive layer 52. In this way, cover layer structure 50 may maintain the ±2 μm thickness variation tolerance across optical disk 72 even when optically transmissive layer 52 is outside of the tolerance range.

Support carrier 56 temporarily bonds to a portion of cover layer structure 50 via hardcoat material 54. Support carrier 56 allows cover layer structure 50 to be transported and applied to substrate 70 (FIG. 4E) of optical data storage disk 72. Support carrier 56 also provides rigidity that enables cover layer structure 50 to be sized according to the dimensions of substrate 70. In addition, support carrier 56 provides a flat surface, which may improve a surface quality of hardcoat material 54.

A first stamper applies a surface pattern to replication material 58. Thin films, such as reflective materials, partially-reflective materials, and phase-change materials, may be applied to replication material 58 after the surface pattern is formed in replication material 58. A rolling bead process or a knife-edged process may be used to apply the first stamper to replication material 58. In this way, the thin films on the bottom surface of replication material 58 may be encoded with the data and tracking information. Replication material 58 may comprise a first data storage layer of dual-layer optical disk 72.

FIG. 4B illustrates replication material 58 with a first surface pattern 62. Removing the first stamper exposes a first surface pattern 62 encoded on the bottom surface of replication material 58. As discussed above, first surface pattern 62 is an inverse of the first stamper surface pattern. The first stamper may include a release agent, such as a Ni thin film, that allows the first stamper to be removed from replication material 58.

FIG. 4C illustrates the fully formed cover layer structure 50. Bonding material 64 is distributed adjacent first surface pattern 62 encoded in the thin films on the bottom surface of replication material 58. Similar to hardcoat material 54 and replication material 58, bonding material 64 may comprise a curable material, such as resin or polymer.

Cover layer structure 50 comprises a thickness within the ±2 μm thickness variation tolerance to allow an optical disk drive to focus a light onto a surface of substrate 70 through cover layer structure 50. Hardcoat material 54, replication material 58, and bonding material 64 may be optically matched to optically transmissive layer 52. Specifically, the index of refraction of optically transmissive layer 52 may be between approximately 1.45 and 1.70, the index of refraction of hardcoat material 54 may be between approximately 1.45 and 1.70, the index of refraction of replication material 58 may be between approximately 1.45 and 1.70, and the index of refraction of bonding material 64 may be between approximately 1.45 and 1.70.

As the indices of refraction increase within the given range, the allowable thickness range of cover layer structure 50 also increases. For example, if optically transmissive layer 52, hardcoat material 54, replication material 58, and bonding material 64 each define an index of refraction of 1.45, the allowable thickness range is approximately 93.75 μm to 103.75 μm. If optically transmissive layer 52, hardcoat material 54, replication material 58, and bonding material 64 each define an index of refraction of 1.70, the allowable thickness range is approximately 97.5 μm to 107.5 μm. As described herein, each of the allowable thicknesses for cover layer structure 50 has a thickness variation tolerance of less than approximately ±2 μm.

In this way, hardcoat material 54, replication material 58, and bonding material 64 may function as part of optically transmissive layer 52. In other words, the light may pass through cover layer structure 50 in a substantially similar manner as passing through a single layer of material, e.g., optically transmissive layer 52. In the illustrated embodiment, hardcoat material 54, replication material 58, and bonding material 64 comprise ultra-violet (UV) materials to optically match with optically transmissive layer 52 of the blue disk medium.

A second stamper applies a surface pattern to bonding material 64. A rolling bead process or a knife-edged process may be used to apply the second stamper to bonding material 64. In this way, bonding material 64 may be encoded with the data and tracking information.

Cover layer structure 50 may be formed by a knife-edged gap process, described in more detail below, in which two or more layers are pulled through the knife-edged gap to distribute beads of material positioned between the layers. For example, a bead of hardcoat material 54 may be positioned between support carrier 56 and a top surface of optically transmissive layer 52 and a bead of replication material 58 may be positioned between a bottom surface of optically transmissive layer 52 and the first stamper. When support carrier 56, optically transmissive layer 52, and the first stamper are pulled through a knifed-edged gap that is set to a specified thickness, hardcoat material 54 and replication material 58 distribute over the top surface and the bottom surface, respectively, of optically transmissive layer 52. After removing the first stamper, another knife-edged gap process may be performed. A bead of bonding material 64 may be positioned between a bottom surface of replication material 58 and the second stamper. Bonding material 64 distributes over a bottom surface of replication material 58 when support carrier 56, optically transmissive layer 52, and the second stamper are pulled through the knife-edged gap.

FIG. 4D illustrates cover layer structure 50 with a second surface pattern 68. Removing the second stamper exposes second surface pattern 68 encoded on bonding material 64. As discussed above, second surface pattern 68 is an inverse of the second stamper surface pattern. The second stamper may include a release agent, e.g., Ni thin film, that allows the second stamper to be removed from bonding material 64.

FIG. 4E illustrates optical data storage disk 72. Cover layer structure 50 bonds to substrate 70 via encoded bonding material 64 to form optical disk 72. Substrate 70 may include a coating of thin films on the surface adjacent bonding material 64. For example, the thin films may include a reflective material, a partially-reflective material, or a phase-change material. Second surface pattern 68 may provide a surface relief pattern to encode the thin films deposited on the surface of substrate 70. In this way, the data and tracking information that was originally encoded on the master surface may be encoded on optical disk 72. Substrate 70 comprises a second data storage layer of dual-layer optical disk 72.

Once cover layer structure 50 bonds to substrate 70, support carrier 56 may be removed to expose hardcoat material 54. Support carrier 56 may comprise a material capable of temporarily bonding to optically transmissive layer 52 via hardcoat material 54 to provide handling support and surface quality, but not permanently adhere to hardcoat material 54.

As stated above, optical disk 72 conforms to a blue disk medium format. In the illustrated embodiment, substrate 70 comprises a thickness of approximately 1.1 mm. Cover layer structure 50 comprises a thickness of 100±2 μm. As an example, optically transmissive layer 52 may be approximately 55 μm thick, hardcoat material 54 may be approximately 10 μm, and encoded replication material 58 may be approximately 10 μm. Bonding material 64 comprises a thickness of approximately 25 μm, which is the minimum distance needed between first surface pattern 62 and second surface pattern 68 to enable an optical disk drive to read both surface patterns. In other embodiments, the components of cover layer structure 10 may conform to different thicknesses as long as the total thickness is within the ±2 μm thickness variation tolerance and the distance between data storage layers is at least 25 μm. The thicknesses of the different layers, however, may be tuned according to other media formats.

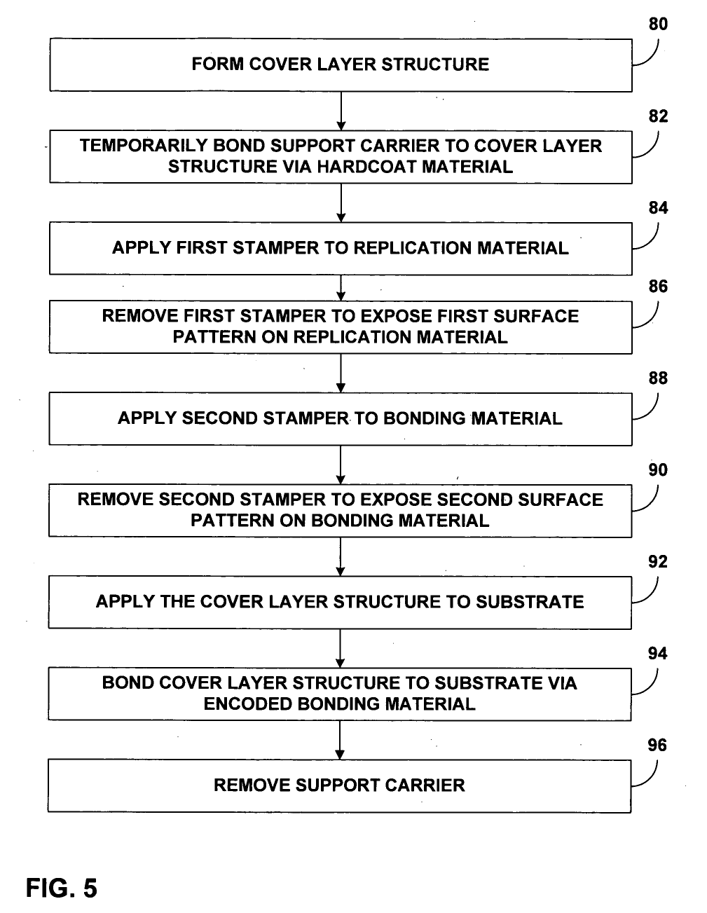

FIG. 5 is a flow chart illustrating an exemplary process of bonding cover layer structure 50 to substrate 70 to form optical data storage disk 72 (FIGS. 4A-4E). Cover layer structure 50 is formed by distributing hardcoat material 54 over the top surface of optically transmissive layer 52, distributing bonding material 64 adjacent the bottom surface of optically transmissive layer 52, and interposing a replication layer 58 between the bottom surface of optically transmissive layer 52 and bonding material 64 (80).

As described above, cover layer structure 50 comprises a thickness, e.g., 100 μm, within a ±2 μm thickness variation tolerance. Materials 54 and 58 comprise curable materials capable of filling in variations on the surfaces of optically transmissive layer 52. Therefore, distributing materials 54 and 58 over a top and bottom surface, respectively, of optically transmissive layer 52 allows cover layer structure 50 to be within the thickness tolerance even with a less expensive, lower quality optically transmissive layer material.

Furthermore, integrating hardcoat material 54 into cover layer structure 50 eliminates a separate hardcoat application process that typically lacks uniformity, e.g., spin coating or vacuum deposition. Eliminating this application process may improve surface uniformity, which enables cover layer structure 50 to maintain a thickness within the tight tolerance across optical disk 72.

Optically transmissive layer 52 defines an index of refraction. Hardcoat material 54, replication material 58, and bonding material 64 are optically matched to optically transmissive layer 52 to allow an optical disk drive to focus a light onto a surface of substrate 70 through cover layer structure 50. In this way, hardcoat material 54, replication material 58, and bonding material 64 may function as part of optically transmissive layer 52 and compensate for irregularities in optically transmissive layer 52.

Support carrier 56 temporarily bonds to cover layer structure 50 via hardcoat material 54 (82). Support carrier 56 provides handling support to transport cover layer structure 50 and size cover layer structure 50 to fit substrate 70 of optical disk 72. The first stamper is applied to replication material 58 (84). Replication material 58 may include a coating of thin films on a bottom surface, first surface pattern 62 may provide for encoding of the thin films on replication material 58 with data and tracking information. The first stamper is then removed to expose first surface pattern 62 (86). The first stamper may include a release agent, e.g., Ni thin film, to enable the removal processes.

The second stamper is then applied to bonding material 64 of cover layer structure 50 (88). The second stamper includes a second stamper surface pattern that encodes second surface pattern 68 on bonding material 64. The second stamper is then removed to expose second surface pattern 68 (90). The second stamper may also include a release agent, e.g., Ni thin film, to enable the removal processes. As described above, cover layer structure 50 may be formed using support carrier 56, optically transmissive layer 52, the first stamper, and the second stamper in knife-edged gap processes, illustrated in FIGS. 6A-6C. In that case, a flat surface of support carrier 56 may provide improved surface quality to hardcoat material 54.

Support carrier 56 applies cover layer structure 50 encoded with first surface pattern 62 and second surface pattern 68 to substrate 70 of optical disk 72 (92). Cover layer structure 50 bonds to substrate 70 via encoded bonding material 64 to form optical data storage disk 72 (94). Thin films, such as reflective materials, partially reflective materials, and phase-change materials, may be applied to a surface of substrate 70 adjacent bonding material 64 prior to bonding cover layer structure 50 to substrate 70. Second surface pattern 68 may provide for an encoding of the thin films on substrate 70 with data and tracking information. Support carrier 56 is then removed to expose hardcoat 54 (96). Support carrier 56 may comprise a material property that allows temporary bonding to provide handling support without permanently adhering to cover layer structure 50.

FIGS. 6A-6C are cross-sectional side views of a knife-edged gap system. The knife-edged gap system described herein may form a cover layer structure substantially similar to cover layer structure 10 (FIGS. 2A-2C). In other embodiments, the knife-edged gap system may form a cover layer structure substantially similar to cover layer structure 50 (FIGS. 4A-4E). The system includes a knife-edged component 100 including a knife-edge 101. Component 100 forms a gap with a distance D between knife-edge 101 and a fixed surface 102. Vertically repositioning component 100 alters the gap thickness D in the knife-edged gap system.

To form a cover layer structure, a support carrier 104, an optically transmissive layer 106, and a stamper 108 are positioned between component 100 and fixed surface 102. A bead of a hardcoat material 105 is positioned for distribution between support carrier 104 and a top surface of optically transmissive layer 106. Similarly, a bead of a bonding material 107 is positioned for distribution between a bottom surface of optically transmissive layer 106 and stamper 108. A nozzle, syringe, pipette, or the like may properly position the beads of material 105, 107. Stamper 108 includes a surface pattern. The bead of bonding material 107 should be positioned at least a small distance before the region of stamper 108 that includes the stamper surface pattern.

The system then pushes or pulls support carrier 104, optically transmissive layer 106, and stamper 108 in a direction 110 through the gap formed by knife-edge 101 and fixed surface 102. An automated arm (not shown) may be used to push or pull the components through the system. As this occurs, knife-edge 101 passes over support carrier 104 to distribute the beads of hardcoat material 105 and bonding material 107 as shown in FIG. 6B. Hardcoat material 105 and bonding material 107 fill surface variations on optically transmissive layer 106. In this way, the cover layer structure may comprise a less expensive, lower quality optically transmissive layer material. Support carrier 104 comprises a flat surface that provides surface quality to hardcoat material 105.

Bonding material 107 also fills the grooves on stamper 108 encoding a surface pattern on bonding material 107. Stamper 108 may be permanently fixed in the knife-edged gap system, or alternatively, stamper 108 may be removable from the knife-edged gap system. If stamper 108 is removable, a variety of different stampers may be inserted in the knife-edged gap system depending on the surface pattern to be encoded.

The knife-edged gap system creates a cover layer structure of a specific thickness based on the distance D between knife-edge 101 and fixed surface 102. As knife-edge 101 passes over support carrier 104 as shown in FIGS. 6A-6C, knife-edge 101 spreads the beads of material 105, 107 such that they are substantially evenly distributed over the top and bottom surfaces of optically transmissive layer 106 with a substantially uniform thickness on each respective side. For example, the materials distributed over optically transmissive layer 106 may provide the cover layer structure with thickness variations less than ±2 μm.

At this point, the materials may be cured to define a protective hardcoat layer on the top surface of optically transmissive layer 106 and an encoded surface pattern on the bottom surface of optically transmissive layer 106. The curing process bonds materials 105 and 107 to optically transmissive layer 106 and preserves the surface pattern defined by stamper 108 and the surface quality defined by support carrier 104. After curing, the cover layer structure may be removed from stamper 108. The cover layer structure may then be bonded to a substrate of an optical data storage disk via encoded bonding layer 108 before removing support carrier 104. If desired, various thin films may be applied prior to bonding the cover layer structure to the substrate.

Various embodiments of the invention have been described. For example, a cover layer structure has been described that includes an optically transmissive layer, a hardcoat material distributed adjacent a top surface of the optically transmissive layer and a bonding material distributed adjacent a bottom surface of the optically transmissive layer. The entire cover layer structure may be bonded to an optical data storage disk substrate via the bonding material. The cover layer structure may comprise a thickness within a ±2 μm thickness variation tolerance. In some cases, the cover layer structure may include a replication material interposed between the bottom surface of the optically transmissive layer and the bonding material. The cover layer structure then forms a dual-layer optical data storage disk.

Nevertheless various modifications can be made to the techniques described herein without departing from the spirit and scope of the invention. For example, although primarily described herein as conforming to a blue media format with a 100±2 μm thick cover layer structure, the cover layer structure may comprise other thicknesses that conform to other optical media formats. These and other embodiments are within the scope of the following claims.

1. A cover layer structure for an optical data storage disk comprising:
an optically transmissive layer defining substantial thickness variations larger than approximately ±2 micrometers, the optically transmissive layer defining an index of refraction;
a first material distributed adjacent a top surface of the optically transmissive layer, the first material defining an index of refraction that substantially matches the index of refraction of the optically transmissive layer; and
a second material distributed adjacent a bottom surface of the optically transmissive layer, the second material defining an index of refraction that substantially matches the index of refraction of the optically transmissive layer, and
wherein the first and second materials are distributed such that a thickness variation tolerance of the cover layer structure is less than approximately ±2 micrometers.

2. The cover layer structure of claim 1, wherein the first material comprises a hardcoat material that protects the optically transmissive layer.

3. The cover layer structure of claim 1, wherein the second material comprises a bonding material that bonds the cover layer structure to a substrate of the optical data storage disk.

4. The cover layer structure of claim 1, wherein the index of refraction of the optically transmissive layer is between approximately 1.45 and 1.70, the index of refraction of the first material is between approximately 1.45 and 1.70, and the index of refraction of the second material is between approximately 1.45 and 1.70.

5. The cover layer structure of claim 1, wherein the optically transmissive layer comprises a rigid polymer.

6. The cover layer structure of claim 1, further comprising a support carrier temporarily bonded to the cover layer structure via the first material, wherein the support carrier transports, sizes, and applies the cover layer structure to a substrate of the optical data storage disk.

7. The cover layer structure of claim 6, wherein the support carrier is removed when the cover layer structure is bonded to the substrate via the second material.

8. The cover layer structure of claim 1, further comprising a surface pattern encoded on the second material.

9. The cover layer structure of claim 1, further comprising a replication material interposed between the bottom surface of the optically transmissive layer and the second material, wherein a first surface pattern is encoded on the replication material and wherein a second surface pattern is encoded on the second material.

10. The cover layer structure of claim 9, wherein the second material comprises a thickness of at least 25 micrometers to separate the first surface pattern encoded on a bottom surface of the replication material from the second surface pattern encoded on a bottom surface of the second material.

11. An optical data storage disk comprising:
a substrate; and
a cover layer structure bonded to the substrate, the cover layer structure including an optically transmissive layer defining substantial thickness variations larger than approximately ±2 micrometers, the optically transmissive layer defining an index of refraction, a first material distributed adjacent a top surface of the optically transmissive layer, the first material defining an index of refraction that substantially matches the index of refraction of the optically transmissive layer, and a second material distributed adjacent a bottom surface of the optically transmissive layer, the second material defining an index of refraction that substantially matches the index of refraction of the optically transmissive layer, and wherein the first and second materials are distributed such that a thickness variation tolerance of the cover layer structure is less than approximately ±2 micrometers.

12. The optical data storage disk of claim 11, wherein the first material comprises a hardcoat material that protects the optically transmissive layer and the second material comprises a bonding material that bonds the cover layer structure to the substrate.

13. The optical data storage disk of claim 11, further comprising a support carrier temporarily bonded to the cover layer structure via the first material, wherein the support carrier is removed after the cover layer structure is bonded to the substrate via the second material.

14. The optical data storage disk of claim 11, wherein the second material includes an encoded surface pattern and the substrate includes a coating of thin films on a surface of the substrate adjacent the second material.

15. The optical data storage disk of claim 11, wherein the cover layer structure includes a replication material interposed between a bottom surface of the optically transmissive layer and the second material, wherein the replication material includes an encoded surface pattern and a coating of thin films.

16. A method comprising:
forming a cover layer structure including an optically transmissive layer, a hardcoat material distributed adjacent a top surface of the optically transmissive layer, and a bonding material distributed adjacent a bottom surface of the optically transmissive layer;
temporarily bonding a support carrier to the cover layer structure via the hardcoat material;
applying the cover layer structure to an optical data storage disk substrate with the support carrier;
bonding the cover layer structure to the optical data storage disk substrate via the bonding material; and
removing the support carrier to expose the hardcoat material.

17. The method of claim 16, further comprising:
applying a stamper to the bonding material; and
removing the stamper to expose a surface pattern encoded on the bonding material.

18. The method of claim 17, wherein forming the cover layer structure comprises:
positioning a bead of the hardcoat material between the support carrier and the top surface of the optically transmissive layer;
positioning a bead of the bonding material between the bottom surface of the optically transmissive layer and an information layer; and
drawing the support carrier, the optically transmissive layer, and the stamper through a knife-edged gap to distribute the hardcoat material over the top surface of the optically transmissive layer and distribute the bonding material over the bottom surface of the optically transmissive layer.

19. The method of claim 16, further comprising:
interposing a replication material between the optically transmissive layer and the bonding material;
applying a first stamper to the replication material;
removing the first stamper to expose a first surface pattern encoded on the replication material;
applying a second stamper to the bonding material; and
removing the second stamper to expose a second surface pattern encoded on the bonding material.

20. The method of claim 19, wherein forming the cover layer structure comprises:
positioning a bead of the hardcoat material between the support carrier and the top surface of the optically transmissive layer;
positioning a bead of the replication material between the bottom surface of the optically transmissive layer and a first stamper;
drawing the support carrier, the optically transmissive layer, and the first stamper through a knife-edged gap to distribute the hardcoat material over the top surface of the optically transmissive layer and distribute the replication material over the bottom surface of the optically transmissive layer;
positioning a bead of the bonding material between the encoded replication material and a second stamper; and
drawing the support carrier, the optically transmissive layer, and the second stamper through a knife-edged gap to distribute the bonding material over the encoded replication material.
